(19) United States
(12) Patent Application Publication
(10) Pub. No.: US 2007/0171232 A1
(43) Pub. Date: Jul. 26, 2007

(54) SYSTEM AND METHOD FOR COLLECTING AND DISTRIBUTING MARKET INFORMATION

(76) Inventors: Steven John Malloy, Redmond, WA (US); Scott Joseph Bean, Seattle, WA (US); Kurtis Reed Bray, Mercer Island, WA (US); Steve Allen Hull, Snoqualmie, WA (US)

Correspondence Address: BLACK LOWE & GRAHAM, PLLC, 701 FIFTH AVENUE, SUITE 4800, SEATTLE, WA, 98104, US

(21) Appl. No.: 11/423,938

(22) Filed: Jun. 13, 2006

Related U.S. Application Data
(60) Provisional application No. 60/690,407, filed on Jun. 13, 2005.
(60) Provisional application No. 60/760,005, filed on Jan. 17, 2006.
(60) Provisional application No. 60/803,601, filed on May 31, 2006.

(51) Int. Cl. G06F 13/00

(52) U.S. Cl. 345/538

(57) ABSTRACT

A method includes providing a first graphical user interface displayable on a display device, the first interface operable to enable a data provider to provide multiple sets of forest-product-market data, each data set being provided by the data provider at a time of the provider's choosing. A second graphical user interface displayable on a display device is provided, the second interface operable to enable a data consumer to view at least one of the data sets.

### PRIORITY CLAIM

This application claims priority to U.S. provisional patent application Ser. No. 60/642,127 filed Jan. 7, 2005 and to U.S. provisional patent application Ser. No. 60/644,327 filed Jan. 13, 2005 and U.S. provisional patent application Ser. No. 60/690,407 filed Jun. 13, 2005 and U.S. patent application Ser. No. 11/329,414 filed Jan. 9, 2006 and U.S. provisional patent application Ser. No. 60/760,005 filed Jan. 19, 2006 and U.S. provisional patent application Ser. No. 60/803,601 filed May 31, 2006. All of the above applications are hereby incorporated by reference in their entirety as if fully set forth herein.

### COPYRIGHT NOTICE

This disclosure is protected under United States and International Copyright Laws. © Silvaris Corporation. All Rights Reserved. A portion of the disclosure of this patent document contains material which is subject to copyright protection. The copyright owner reserves all copyright rights whatsoever.

### FIELD OF THE INVENTION

An embodiment of the invention relates generally to computer-network applications and, more specifically, to network- and Internet-based software and systems to facilitate more efficient and convenient purchase and sale of items of inventory.

### BACKGROUND OF THE INVENTION

The forest products marketplace is large and complicated, with thousands of producers, wholesalers, distributors, and end users. This marketplace has a vast array of specific products and product features, constant flux in pricing and availability of both the product and transportation, and poor transparency into real pricing and availability of even the most commoditized products. Quality market information is available only to those actively shopping and/or selling products in the marketplace, thereby collecting bids and asks on a daily, continuous basis. Unlike the securities markets, for example, where price, volume and market analytics are readily available to a wide audience, forest products are bought and sold with unclear notions of their real current worth in the broader marketplace.

Today there exist several publications that purport to be authorities on various forest product market prices, but they suffer from problems in data collection and presentation, latency, comprehensiveness, and credibility. Information is primarily collected via qualitative polling converted to numerical data, and the information is clouded by opinions of the subjects and collectors, lacks volume indicators, is sampled inconsistently throughout a broad range in the forest-products distribution channel, excludes important products and regions in the market, and is presented in statistically inaccurate methods. In part because of the slow and qualitative polling methods of data collection, delivery of the market information through these publications is latent—a week and more behind the current market—and suffers from a layer of exceptions, explanations, and qualifiers that cloud and confuse the presentation of the results. These publications are designed for paper-based layout and delivery; they are not widely available interactive software applications that allow users to view, search, sort, configure, analyze, or otherwise present the data in a personalized way. The credibility of these publications is widely suspect because of the above problems; the tool is flawed therefore the conclusions are as well. As such, without quality information about product prices and volume, players in the forest products market have a very murky view of the field.

### BRIEF DESCRIPTION OF THE DRAWINGS

Embodiments of the present invention are described in detail below with reference to the following drawings.

FIG. 1 illustrates an overview of a system and method to facilitate collecting forest-products market information from data providers, storing and processing the data, then disseminating it to the data consumers according to an embodiment of the invention;

FIG. 2 is a schematic depiction of the methods and systems during transmission of market information from data providers to data consumers according to an embodiment of the invention;

FIG. 3 is an expansion of the methods and systems associated with step 200 of FIG. 2 according to an embodiment of the invention;

FIGS. 4-7 depict screenshot examples visible to data providers that help implement many of the embodiments described herein, including, without limitation, the exemplary methods and systems of FIGS. 1, 2, and 3;

FIG. 8 is a schematic depiction of the exemplary methods and systems associated with step 300 of FIG. 2;

FIGS. 9 and 10 depict screenshot examples visible to data providers that help implement many of the embodiments described herein, including, without limitation, the exemplary methods and systems of FIGS. 1, 2, and 8;

FIG. 11 is an expansion of the exemplary methods and systems associated with step 400 of FIG. 2;

FIGS. 12-15 depict screenshot examples visible to data consumers that help implement many of the embodiments described herein, including, without limitation, the exemplary methods and systems of FIGS. 1, 2, and 11;

FIG. 16 is a schematic view of an exemplary operating environment in which an embodiment of the invention can be implemented; and

FIG. 17 is a functional block diagram of an exemplary operating environment in which an embodiment of the invention can be implemented.

### DETAILED DESCRIPTION OF THE PREFERRED EMBODIMENTS

An embodiment of the invention includes network-based software interfaces, business rules, data structures, data, and/or interactions between these interfaces, rules, structures, and/or data. An embodiment of the invention collects and disseminates description, quantity, price and/or volume information about the forest products marketplace via a networked software application. It collects demographic information about the sellers and buyers. It provides comprehensive and statistically valid information in a timely manner, and allows information consumers to tailor their experience to get the most value from the data. An embodiment of the invention includes a market information source that is more reliable, germane, comprehensive, and timely than current methods of collecting and distributing similar information.

A business purpose of an embodiment of the invention includes deriving revenues via subscriptions or usage fees for consuming the market information (e.g., viewing the aggregated data, historical information, analysis, forecasts, and/or raw data). Revenues may also be derived from advertising, trading financial contracts based on the market data, and licensing the data or analyses to third parties.

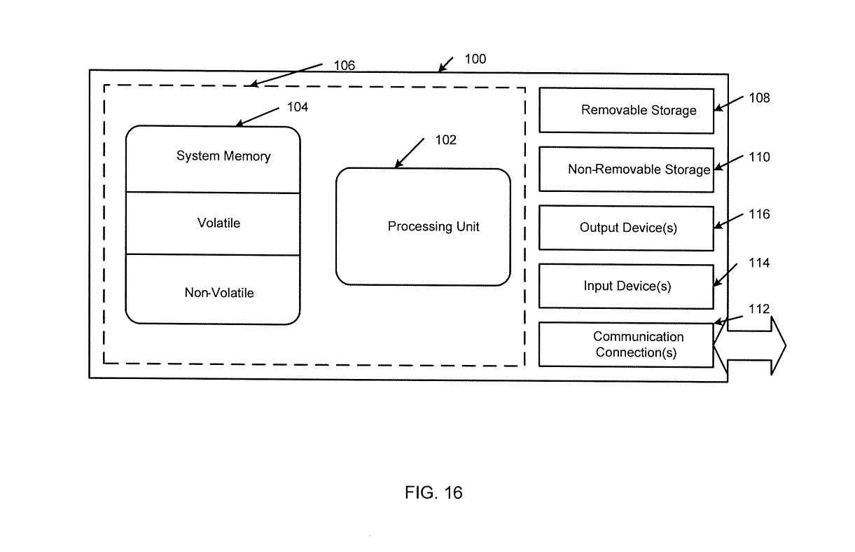

FIG. 16 illustrates an example of a suitable computing system environment 100 on which an embodiment of the invention may be implemented. The computing system environment 100 is only one example of a suitable computing environment and is not intended to suggest any limitation as to the scope of use or functionality of embodiments of the invention. Neither should the computing environment 100 be interpreted as having any dependency or requirement relating to any one or combination of components illustrated in the exemplary operating environment 100.

Embodiments of the invention are operational with numerous other general-purpose or special-purpose computing-system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, distributed-computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed-computing environment, program modules may be located in both local- and remote-computer storage media including memory storage devices.

With reference to FIG. 16, an exemplary system for implementing an embodiment of the invention includes a computing device, such as computing device 100. In its most basic configuration, computing device 100 typically includes at least one processing unit 102 and memory 104.

Depending on the exact configuration and type of computing device, memory 104 may be volatile (such as random-access memory (RAM)), non-volatile (such as read-only memory (ROM), flash memory, etc.) or some combination of the two. This most basic configuration is illustrated in FIG. 16 by dashed line 106.

Additionally, device 100 may have additional features/functionality. For example, device 100 may also include additional storage (removable and/or non-removable) including, but not limited to, magnetic or optical disks or tape. Such additional storage is illustrated in FIG. 16 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communications connection(s) 112 that allow the device to communicate with other devices. Communications connection(s) 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. The term computer-readable media as used herein includes both storage media and communication media.

Device 100 may also have input device(s) 114 such as keyboard, mouse, pen, voice-input device, touch-input device, etc. Output device(s) 116 such as a display, speakers, printer, etc. may also be included. All such devices are well-known in the art and need not be discussed at length here.

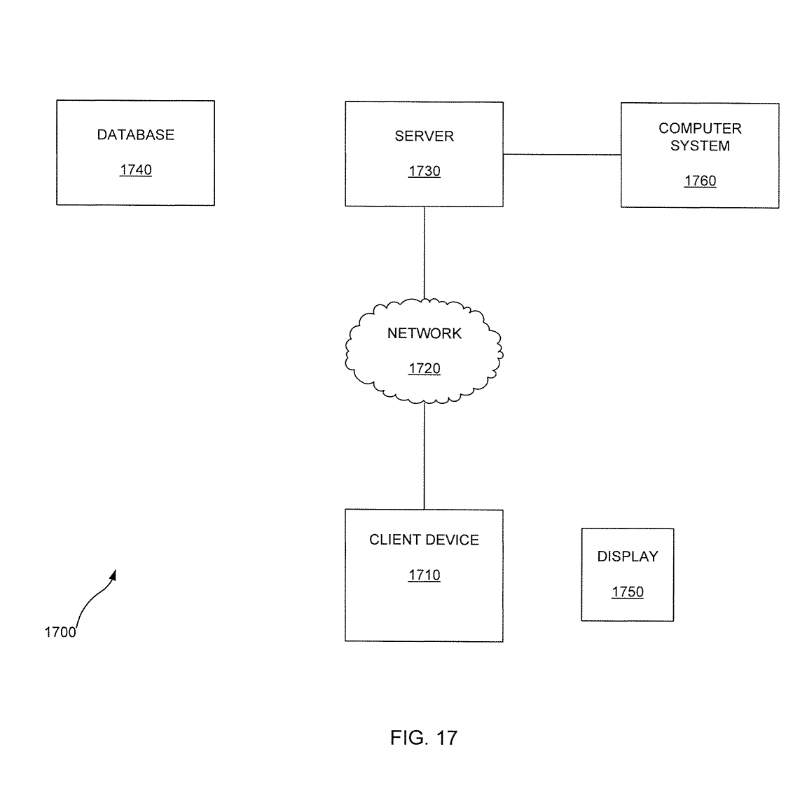

Referring now to FIG. 17, an embodiment of the present invention can be described in the context of an exemplary computer network system 1700 as illustrated. System 1700 includes an electronic client device 1710, such as a personal computer or workstation, that is linked via a communication medium, such as a network 1720 (e.g., the Internet), to an electronic device or system, such as a server 1730. The server 1730 may further be coupled, or otherwise have access, to a database 1740 and a computer system 1760. Although the embodiment illustrated in FIG. 17 includes one server 1730 coupled to one client device 1710 via the network 1720, it should be recognized that embodiments of the invention may be implemented using one or more such client devices coupled to one or more such servers.

In an embodiment, each of the client device 1710 and server 1730 may include all or fewer than all of the features associated with the device 100 illustrated in and discussed with reference to FIG. 16. Client device 1710 includes or is otherwise coupled to a computer screen or display 1750. As is well known in the art, client device 1710 can be used for various purposes including both network- and local-computing processes.

The client device 1710 is linked via the network 1720 to server 1730 so that computer programs, such as, for example, a browser, running on the client device 1710 can cooperate in two-way communication with server 1730. Server 1730 may be coupled to database 1740 to retrieve information therefrom and to store information thereto. Database 1740 may include a plurality of different tables (not shown) that can be used by server 1730 to enable performance of various aspects of embodiments of the invention. Additionally, the server 1730 may be coupled to the computer system 1760 in a manner allowing the server to delegate certain processing functions to the computer system.

Data providers are sellers of forest products that may include loggers; sawmills and/or manufacturers who are primary producers of lumber, panels, and/or other forest products; secondary producers of wood-based products including re-manufacturing facilities; wholesalers and/or resellers; and/or stocking distributors. Data providers periodically supply historical sales order data to the system. The data may be provided daily or more frequently, but may also be provided on a less frequent basis. This sales order data may include but is not limited to individual order details including a description of the products sold, quantity sold in the appropriate units, price per each item sold in the appropriate units, destination, sale date, estimated ship date, and/or other information. Data providers may also provide market data on their intended sale prices in the future, as well as indicators of their current or forecast production capacity or inventory levels.

Data consumers may include but are not limited to users at the data providers (including company management, salespeople, financial analysts, product planners, and/or others), managers and/or purchasing agents at end-user customers (retailers, contractors, manufacturers), financial analysts, academics and/or researchers, government economists, trade representatives, and/or reporters and/or other members of the news media, and/or other users. Data consumers are enabled to view aggregate market information on specific products within defined market regions. This information may include but is not limited to values for the average, median, high and/or low prices for specific products sold within the market for the most recent reporting period, volume indicators for the reporting period, indicators of price and/or volume changes over several previous periods. The market information displayed to data consumers may also include price, volume, and/or price movement on proprietary product composite indices that are compiled by the system. For example all sales of oriented strand board and/or plywood of any grade, dimension, source and/or delivery destination may be aggregated into single composite numbers for panel prices and/or volume as an indicator of the overall wood panel market. The market information may also include indications of current prices offered by an aggregated group of sellers, as well as forecasts of price and/or volume in the future based on statistical analysis. Data providers who also consume the data may have indications of their price and/or volume relative to the aggregated group of similar products and/or sellers within their geographic markets.

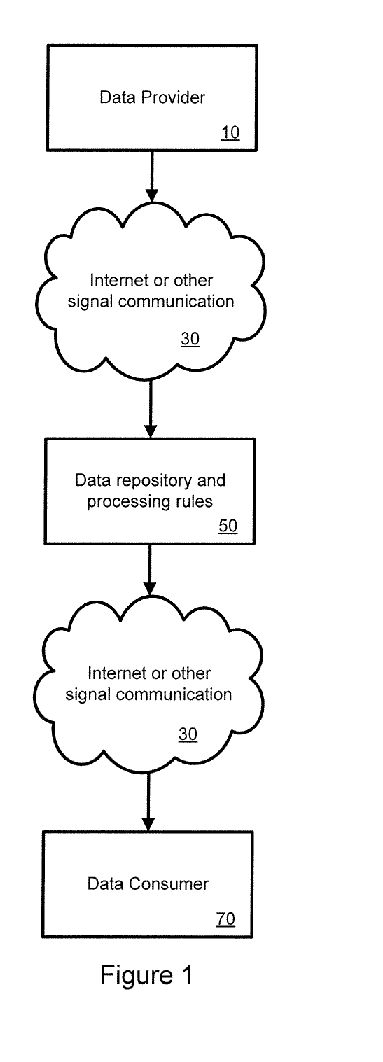

FIG. 1 illustrates a system, according to an embodiment of the invention, which may be implemented to allow a data provider to provide market information to a data consumer.

By employing a client device 10, which may have the same or similar functionality as the client device 1710 of FIG. 17, a data provider uses Internet or similar network communications 30, which may have the same or similar functionality as the network 1720 of FIG. 17, to access and/or provide data to a data repository 50, which may have the same or similar functionality as the server 1730 and/or database 1740 of FIG. 17. This data may be aggregated from multiple providers of same or similar products and/or processed for presentation via the Internet 30 to at least one data consumer employing a client device 70, which may have the same or similar functionality as the client device 1710 of FIG. 17.

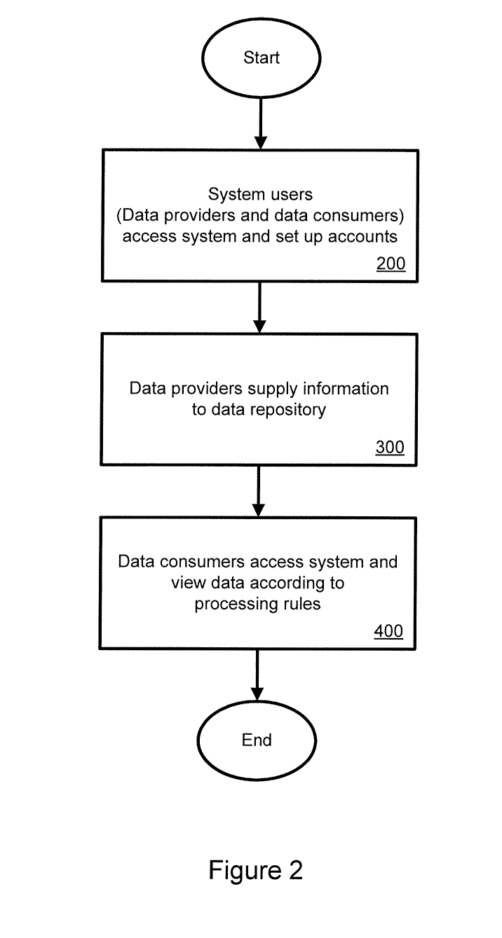

FIG. 2 illustrates a process implementable in the system of FIG. 1. In block 200, one or more users of the system provide detailed profiles about their businesses, the people using the system to provide and/or consume market information, and/or the user preferences for how the system responds to their inputs. In block 300, data providers supply market data to the system. In block 400, and as discussed more fully hereinafter, the system provides market information to data consumers via a variety of methods.

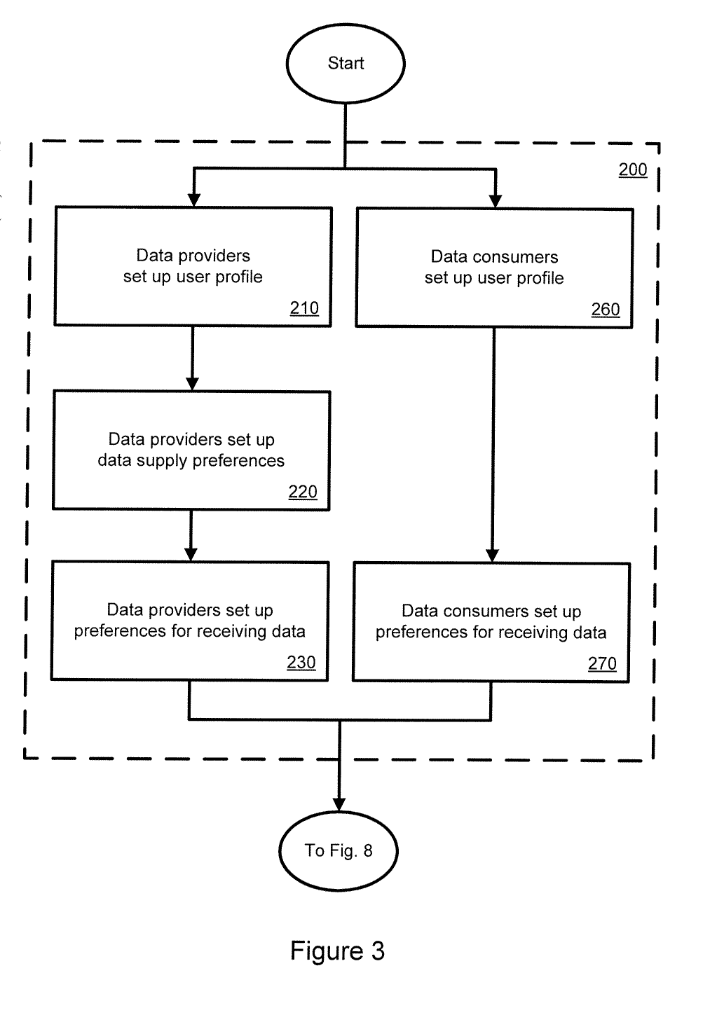

FIG. 3 provides further detail on sub-steps associated with block 200 of FIG. 2 according to an embodiment of the invention. In block 210, data providers register a company and/or personal user profile with the system. This profile information may include but is not limited to contact details, product information, facility data, and/or company data. Contact details may include name, company name, address, city, state/province, zip/postal code, telephone, fax, email address, password, and/or facilities under the company that are within the contact's control and/or therefore market focus according to the system. Product information may include product describers including identification numbers, common names, and/or product-specific attributes. In the example of lumber, product-specific attributes include product dimensions, grade, species, moisture, surfacing, and/or length. The user may also select to identify a daily volume of product shipped and/or a price to be used as a default volume and/or price point. Facility data may include location, location common names, production capacity per facility and/or other items. Company information may include SIC and/or NAICS codes, line of business selections, revenues, and/or other key financial metrics.

Profiles allow the system to categorize the users, facilities, and/or companies within the system. The system's categorization scheme determines how data is aggregated and/or later represented back to data consumers. For example, the price and/or volume data provided by a sawmill that manufactures 2×4 studs is categorized as distinct from the price and/or volume data provided by a wholesaler of the same or similar commodity. The categorization within the system allows this distinction to provide precision in market data sampling and/or reporting to data consumers.

In FIG. 3, block 220, preferences are established for data provider input into the system such as units of measure, currencies, upload periods and/or timing, etc. If software is to be integrated into a data provider's own order processing software to collect and/or upload the data to the system's data repository, linkage preferences may be provided in this step.

In FIG. 3, block 230, preferences may be established for a data provider's view of the aggregated market data. This is the data consumer's display of details such as product attributes, units of measure, currencies, time zones, email summary delivery times, methods of communication—web, email, fax, or other. Users may also define product market indexes they wish to see summarized in their view, and/or define the default geographical region for display of the aggregated market data they view. This may be a user-editable grouping of telephone area codes and prefixes, postal and/or zip codes, counties and/or parishes, states and/or provinces, and/or countries.

Preferences also provide the ability for users to define product alerts or watch lists for specific market events. These events may include crossing up or down through threshold prices, volume triggers, or statistically determined triggers such as a moving average price being crossed. Other preference settings include the user's preferred delivery method for these alerts—email, text message, voice message, instant message, fax, and/or other.

In FIG. 3, block 260, data consumers may register a company and/or personal user profile with the system. This profile information may include but is not limited to contact details, product information, facility data, and/or company data. This process is similar to the process of block 210 described above, except the data consumers may not register production and/or data provision details.

In FIG. 3, block 270, data consumers may register data viewing preferences with the system. This process may be similar to process of block 230 described above.

Within FIG. 3, blocks 210, 220, and/or 230 may be combined in a single process or performed in a different sequence. The same is true with respect to blocks 260 and 270.

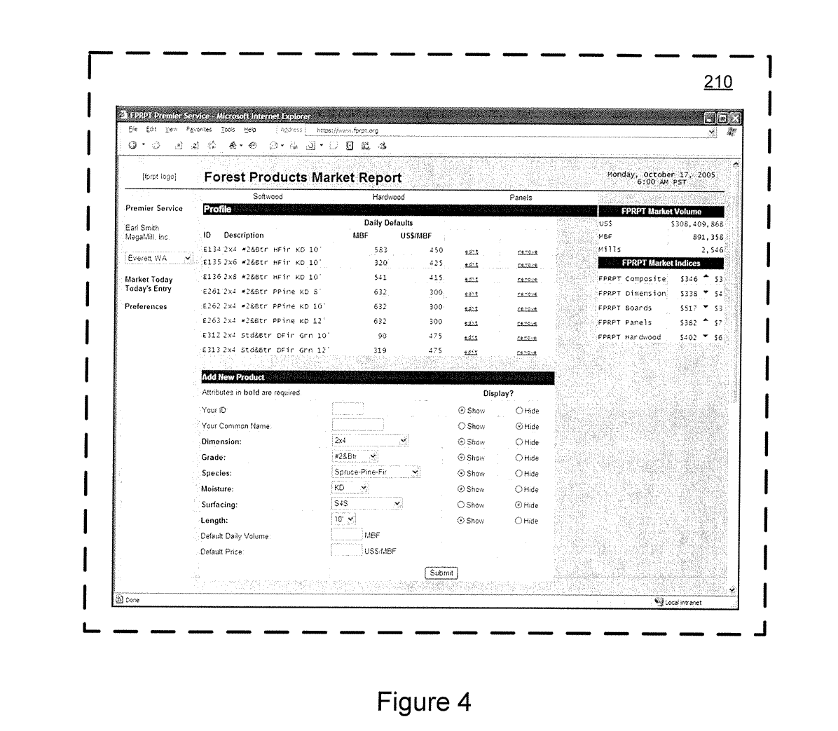

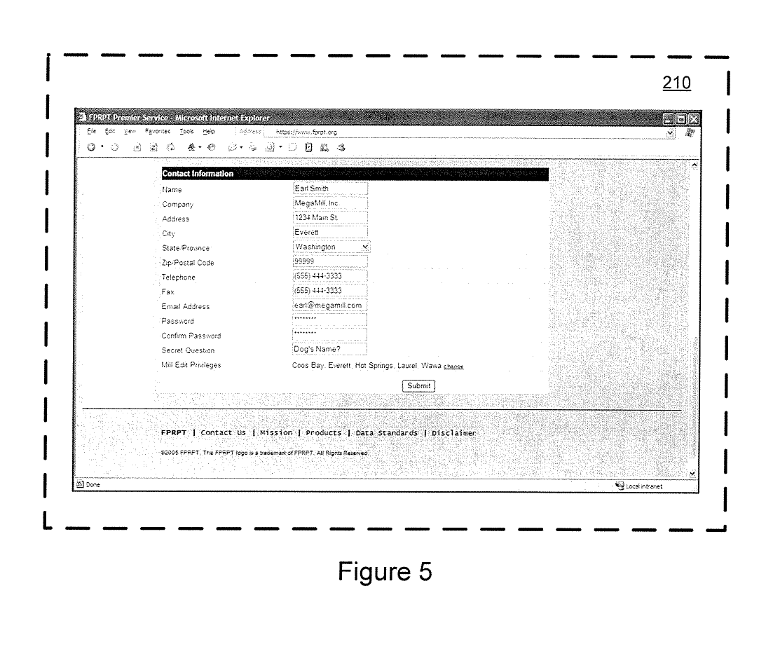

FIG. 4 shows, according to an embodiment of the invention, an exemplary screenshot visible to data providers in FIG. 3, block 210 as a user establishes a profile. Displayed are exemplary elements for several screens in the system: branding elements, current date and/or time, tools for navigating the screens, and/or data consumer information including summary views of current market information shown as overall dollar volume, unit volume, and/or supplier mills contributing to the system, and/or price and/or movement information for various composite indices. Other data may be shown on this screen; for example, a number representing the total number of orders included in the period represented by the overall volume indicators. A user clicking the Submit button may be shown the contents of FIG. 5.

FIG. 5 shows an exemplary screenshot visible to data providers in FIG. 3, block 210 as a user establishes a profile according to an embodiment of the invention. This screen may be seen if a user scrolls down in their web browser while viewing the content in FIG. 4. This page may include, for example, contact details, access security information, and settings to select facilities controlled by the user.

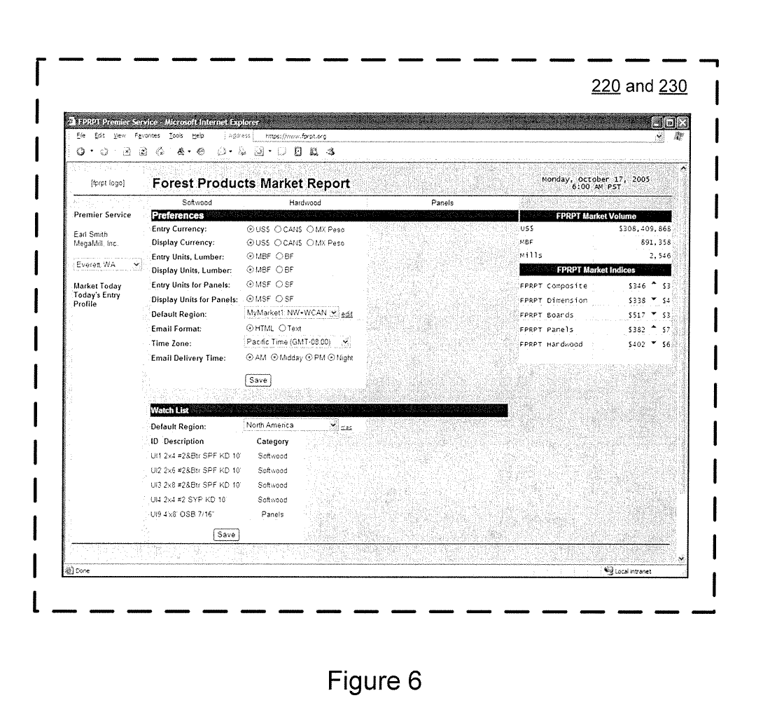

FIG. 6 shows an exemplary screenshot visible to data providers in FIG. 3, block 220 and/or 230 as a user establishes preferences with the system according to an embodiment of the invention. This may display preferences the user may change for both providing data to the system and/or for viewing aggregated market data from the system. The preferences set may include but is not limited to the user's preferred monetary currency of any type, preferred product measurement units (including North American units, metric, and/or other), a geographical region or several regions for viewing product comparisons, email settings, upload periods and/or timing, and linkage preferences to other systems. The screen may also include watch lists for viewing market information on related products in specified regions, alerts, and settings to control which product market indexes are summarized in for view.

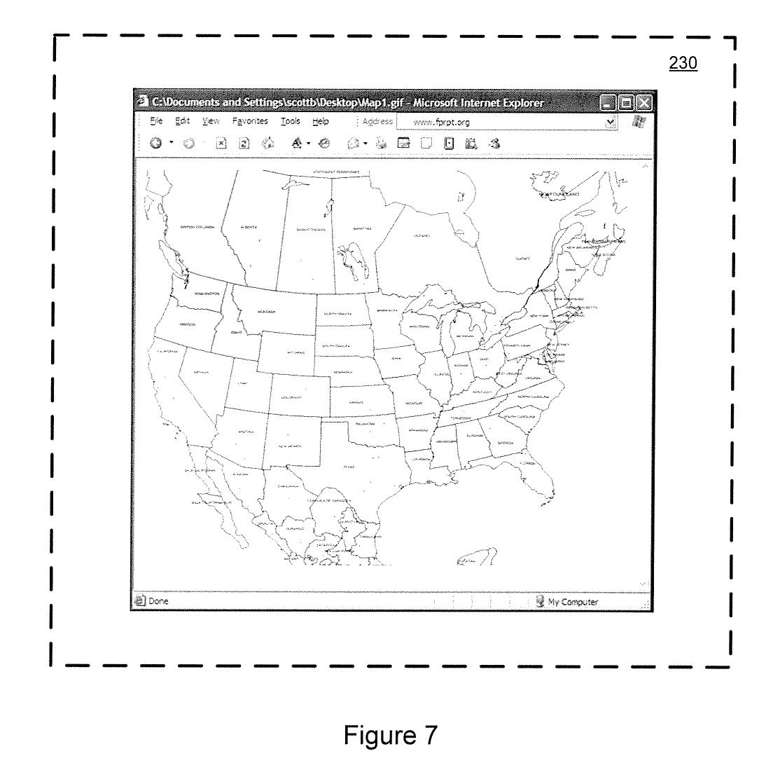

FIG. 7 shows an exemplary screenshot visible to data providers and/or data consumers defining a customized geographical market region for product comparisons, an option of FIG. 3, block 230 and/or block 270 according to an embodiment of the invention. This screen may be displayed if a user clicks the “edit” or “map” links to the right of the “Default Region” drop-down menu boxes shown in FIG. 6. The user can click on specific geographic regions to define a geographic market region for reporting market summary information. When reporting market data to viewers, the system may automatically expand a user's preferred geographical region of interest in order to provide a statistically valid minimum number of data providers in aggregate. For example, if the user chooses a single state as his preferred reporting region and/or that region only includes one data provider for a specific product of interest, the system may expand, or prompt the user to expand, the geographical region to bring in a larger number of data providers.

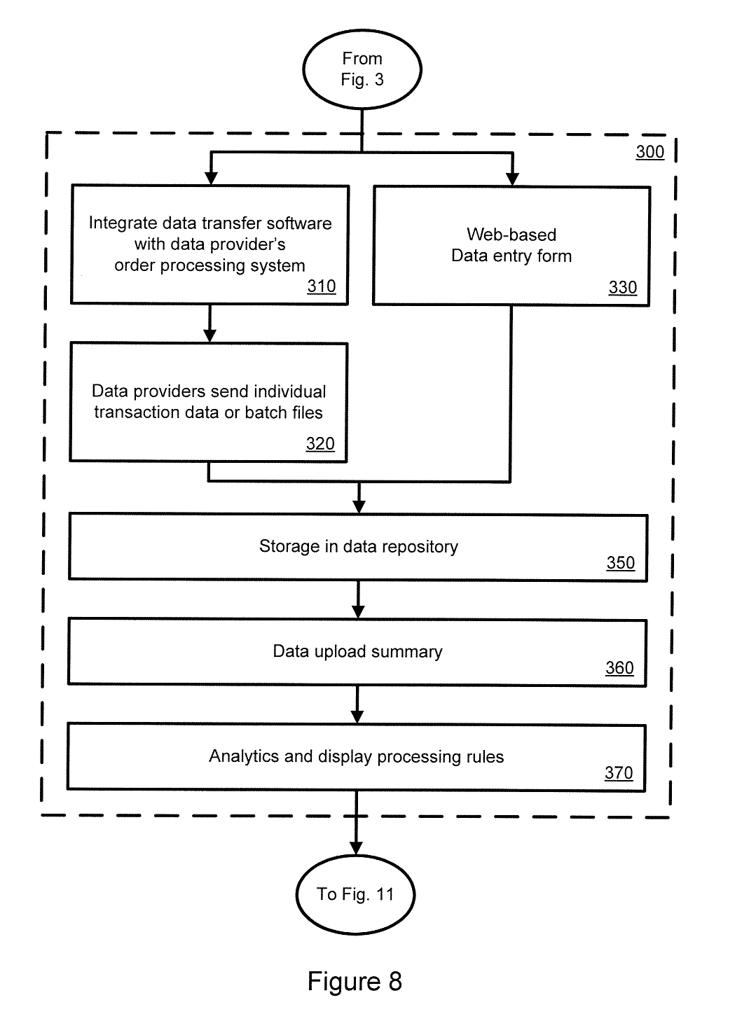

FIG. 8 provides further detail on sub-steps associated with block 300 in FIG. 2 as data is provided to the system according to an embodiment of the invention. Data providers may have different ways of providing sales-order data to the system. As shown in block 310, data providers may choose to integrate a connecting piece of software to their order processing system, which can retrieve the data provider's sales order data and/or upload it to the system's data repository on a periodic basis (real-time, hourly, daily, or less frequently), as shown in block 320. These data transmissions over the network may input data directly into the system's data repository, or upload files that are batch processed into the system's database. Data may include but is not limited to product description by specific product attributes (dimensions, grade, species, surfacing, moisture, etc), quantity sold, price sold, how sold (FOB Mill or Delivered), the shipping destination, number of orders, and/or other data. Note that this data transmission could be XML, EDI, and/or flat data files and/or other methods. Alternatively, transaction data may be entered into the system through web-based forms, as shown in FIG. 8, block 330. The system may also provide correction abilities for canceled or altered orders, whether or not the data is integrated or entered via form. Data may be stored as shown in block 350. After transmission of data to the system is complete, a summary of the data transmitted may be made available to the data provider, as shown in block 360. Within block 370, the system may use statistical analysis, user preferences, subscription privileges, and/or other system rules, rights and/or restrictions to determine which aggregated market data is available for display to each individual data consumer. User interactions with the system may determine the resulting display that a user sees.

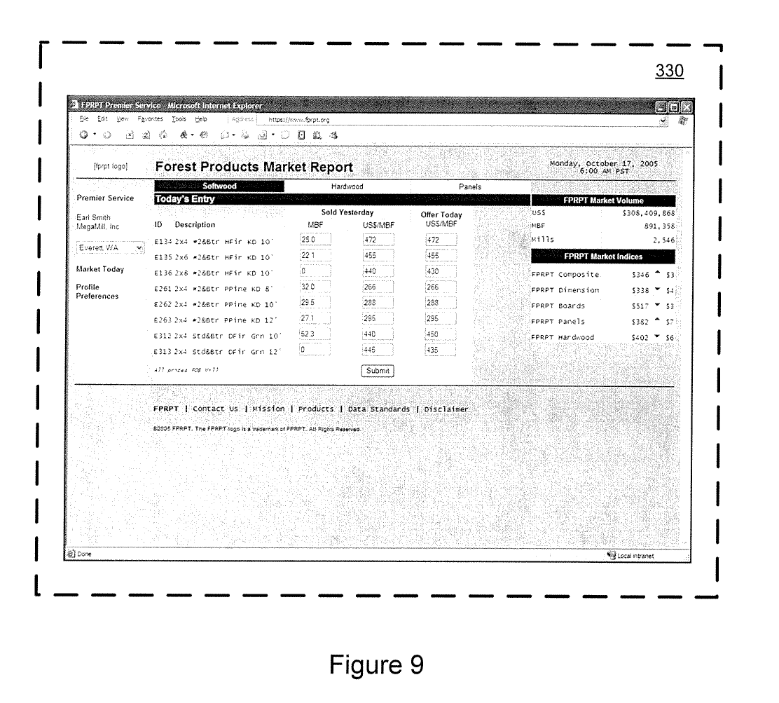

FIG. 9 shows an exemplary screenshot visible to data providers in FIG. 8, block 330 as a data provider user enters market data into a web-based form according to an embodiment of the invention. Displayed are screen elements discussed above, product identifiers and/or descriptors, and/or indicators of the quantity and/or price sold for specific products within the reporting range, as well as an indicator of the seller's offer price for future sales. Further details on the number of orders entered, destinations, and/or other information may also be provided.

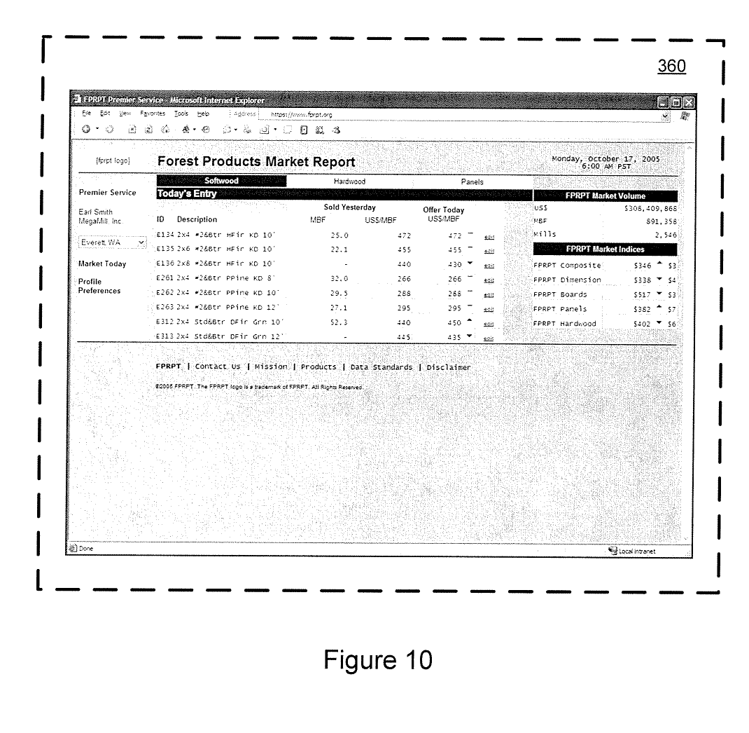

FIG. 10 shows, according to an embodiment of the invention, an exemplary screenshot visible to data providers in FIG. 8, block 350 as a data provider user views a summary of the market information submitted to the system, as well as an indicator of the change in the user's offer price relative to the previous price on each product being sold and/or offered.

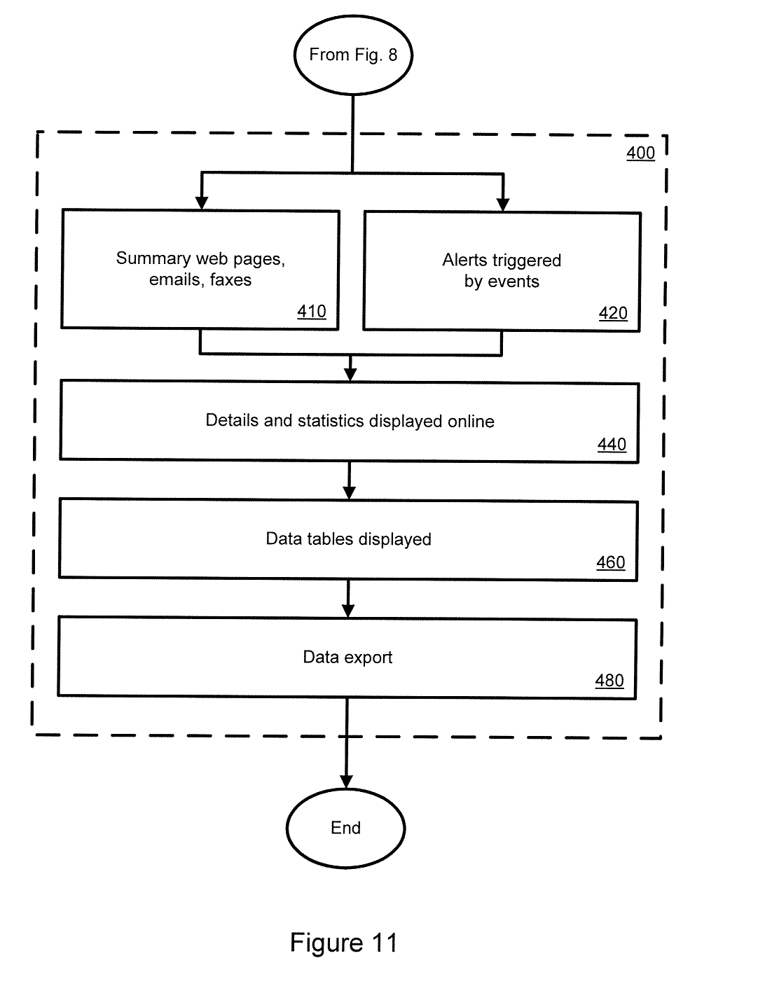

FIG. 11 provides further detail on sub-steps involved in block 400 in FIG. 2 as data is provided to data consumers according to an embodiment of the invention. In block 410, summary web pages may be created by the system and/or displayed to users, and/or emails, faxes and/or other communications may be sent with summary market information. This information may include the market aggregate price and/or volume for products specified by each user, plus indicators of the total volume of reported, and/or proprietary market indexes. In block 420, alerts triggered by events such as product price movements through a threshold price may be displayed to data consumers. These communication preferences may be managed by user preferences as discussed above. In block 440, users may respond to the information displayed by “drilling down” to view specific details on particular products or aggregated product indices to retrieve historical graphs; advanced statistical analysis; forecasts; comparisons with other products, indices, and/or regions; and/or other options as allowed by the system's analytics (FIG. 8, block 370) and/or as permitted by each user's individual privileges. For example, some data consumers in Oregon may wish to compare the price of local Douglas Fir with the price of Southern Yellow Pine from Texas. In block 460, they may also view data in tabular format for export and/or use in other applications.

Data consumers may not be able to disintegrate the system's aggregate market data to get information on specific suppliers or even a small set of suppliers. Data consumer views can be limited to statistically-valid sample sizes and/or displays. For example, users may not be able to obtain specific details on the price and/or volume of 2×4 #3 HemFir KD S4S 10′ in Idaho because there are too few producers, but they may be able to get price and/or volume for all HemFir lumber in Idaho, or all 2×4 #3 HemFir in the Pacific Northwest (a broader region). This data aggregation may also protect individual data providers from revealing their specific prices and/or volume to competitors.

Data consumers may also view advertisements, lumber and/or panel futures data, forest products news, editorial commentary, regional weather reports, currency data, other market indicators (housing starts, mortgage rates, durable goods index, etc.), currency values, etc.

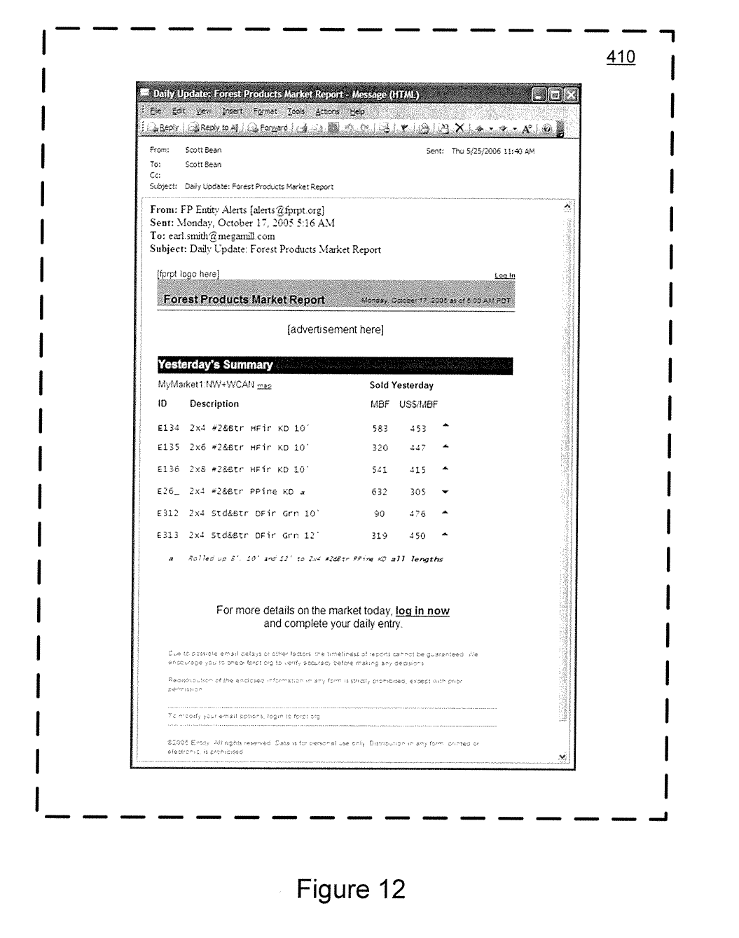

FIG. 12 shows an exemplary email visible to data consumers in FIG. 11, block 410 showing a market data summary according to an embodiment of the invention. Displayed are aggregate price and/or volume data and/or movement indicators for a selection of forest products, including an example of a set of products that has been aggregated together to a more generalized product description for lack of available data on a particular attribute, as discussed above. In the example, all 8′, 10′ and/or 12′ lengths have been collected into one group for reporting.

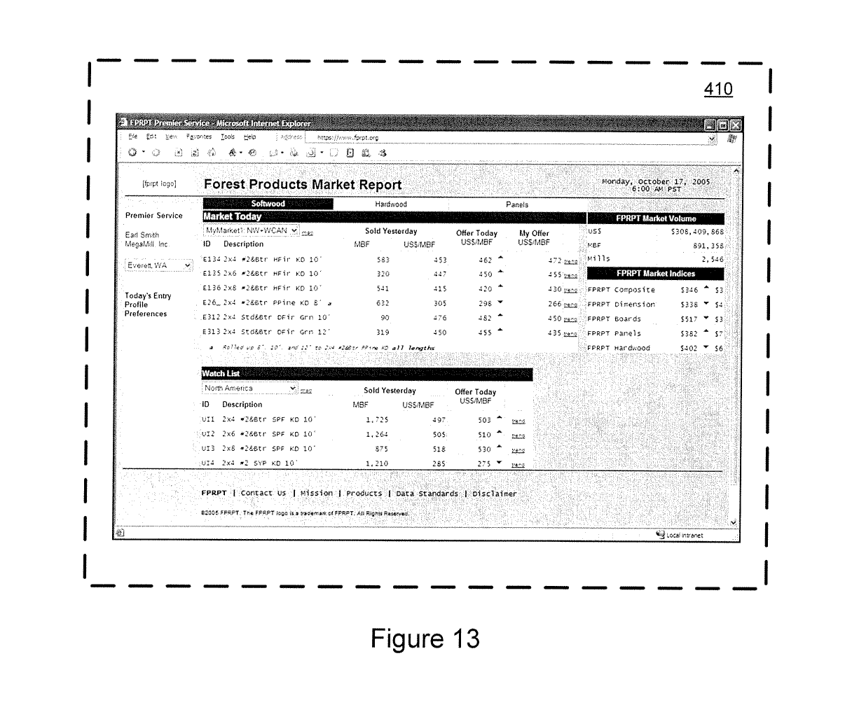

FIG. 13 shows an exemplary web page visible to a consumer of market data summary information as shown in FIG. 11, block 410 according to an embodiment of the invention. Also displayed are screen elements discussed above, including a summary of a watch list.

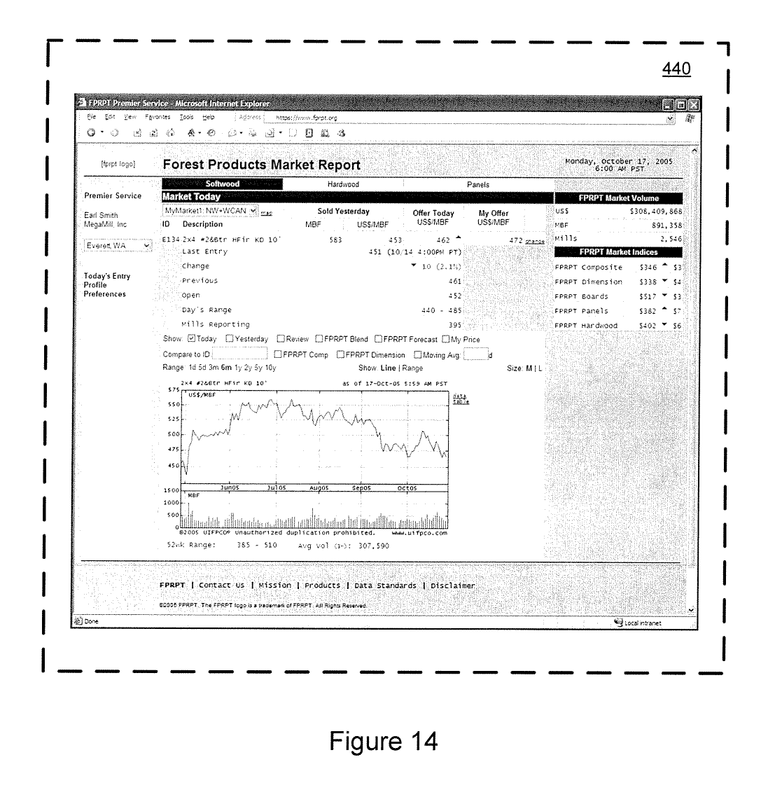

FIG. 14 shows an exemplary web page visible to a consumer of market data summary information as shown in FIG. 11, block 440 according to an embodiment of the invention. This screen may be displayed if a user clicks the “trend” links products listed in FIG. 13.

FIG. 14 shows an exemplary web page visible to a consumer of market data summary information as shown in FIG. 11, block 440 according to an embodiment of the invention. This screen may be displayed if a user clicks the “trend” link next to the products listed in FIG. 13.

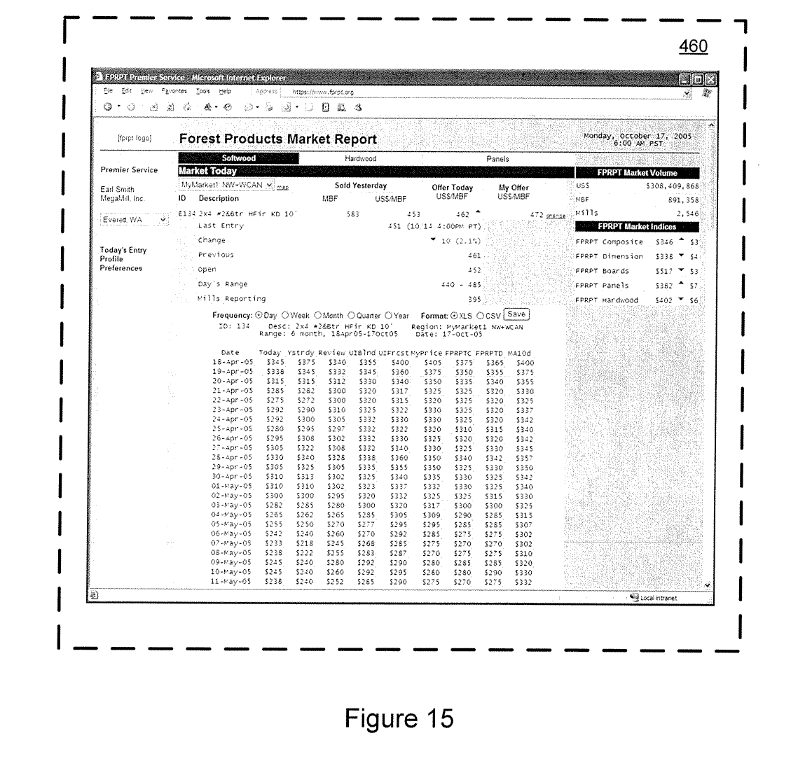

FIG. 15 shows an exemplary web page visible to a consumer of market data summary information as shown in FIG. 11, block 460 according to an embodiment of the invention. This screen may be displayed if a user clicks the “data table” link products listed in FIG. 14. Clicking the “Save” button on the screen in FIG. 15 may create a data export as shown in FIG. 11, block 480.

The screen shots in FIGS. 4-7, 9-10, and/or 12-15 depict one embodiment for implementing many of the features, functions and/or embodiments described above. An example of source code implementing some of the embodiments follows:

/// profile.htm /// <html> /// <head> /// <link rel=“STYLESHEET” href=“_private/MainStyle.css” type=“text/css”> /// <meta name=“GENERATOR” content=“Microsoft FrontPage 6.0”> /// <title>FPRPT Premier Service</title> /// </head> /// <body bgcolor=“#EAD690”> /// <table border=“0” width=“100%” height=“334”> /// <tr> /// <td width=“8%” bgcolor=“#FFFFFF” height=“39” nowrap><p align=“center”> /// <font face=“Arial”>[fprpt logo]</font></td>/// <td width=“1%” height=“39”></td>/// <td width=“63%” nowrap colspan=“8” height=“39”><big><big><strong><font face=“Arial”>Forest /// Products Market Report<sup></sup></font></strong></big></big></td> /// <td width=“22%” colspan=“2” nowrap bgcolor=“#EAD690” height=“39”><font color=“#FFFFFF”><p /// align=“center”></font>Monday, Oct. 17, 2005<br> /// 6:00 AM PST</td> /// </tr> /// <tr> /// <td width=“94%” height=“a” nowrap colspan=“12” bgcolor=“#000000”></td> /// </tr> /// <tr> /// <td width=“8%” height=“21” nowrap></td> /// <td width=“1%” height=“21”></td> /// <td width=“21%” bgcolor=“#EBEBEB” align=“center” height=“21” colspan=“2”> /// <strong style=“font-weight: 400”> /// <a href=“Today.htm”> /// <font face=“Arial” style=“font-size: smaller” color=“#000000”>Softwood</font></a></strong></td> /// <td width=“21%” align=“center” height=“21” bgcolor=“#EBEBEB” colspan=“2”> /// <a href=“drafts/Forecast.htm”> /// <font face=“Arial” style=“font-size: smaller” color=“#000000”>Hardwood</font></a></td> /// <td width=“21%” align=“center” height=“21” bgcolor=“#EBEBEB” colspan=“4”> /// <a href=“Today2.htm”> /// <font face=“Arial” style=“font-size: smaller” color=“#00000”>Panels</font></a></td> /// <td width=“22%” colspan=“2” nowrap height=“21” bgcolor=“#EAD690”></td> /// </tr> /// <tr> /// <td width=“8%” height=“244” nowrap bgcolor=“#EBEBEB” rowspan=“42” valign=“top”><p /// align=“left”><strong><font face=“Aral”>Premier</font></strong><font face=“Arial”><strong>Service</strong></p> /// <p>Earl Smith<br> /// MegaMill, Inc.</p> /// <form method=“POST” action=“—WEBBOT-SELF—” on Submit=“location.href=“_derived/nortbots.htm”;return false;” webbot-on Submit> /// <!—webbot bot=“SaveResults” U-File=“_private/form_results.csv” S-Format=“TEXT/CSV” S-Label-Fields=“TRUE” startspan—><input TYPE=“hidden” NAME=“VTI-GROUP” VALU E=“0”><!—webbot bot=“SaveResults” i-checksum=“43374” endspan —> /// <p> /// <select size=“1” name=“D1”> /// <option>Coos Bay, OR</option> /// <option selected>Everett, WA</option> /// <option>Hot Springs, AR</option> /// <option>Laurel, MS</option> /// <option>Wawa, ON</option> /// </select></p> /// </form> /// <p><b><a style=“text-decoration: none” href=“Today.htm”> /// <font color=“#00000”>Market Today</font></a><br> /// <a style=“text-decoration: none” href=“Entry.htm”><font color=“#00000”>Today's Entry</font></a><br> /// <a style=“color: #FFFFFF; text-decoration: none” href=“Profile.htm”>Profile</a><br> /// <a style=“color: rgb(0,0,0); text-decoration: none” href=“Prefs.htm”>Preferences</a></b></font></td> /// <td width=“1%” height=“21”></td> /// <td width=“63%” align=“center” height=“21” colspan=“8” bgcolor=“#800000”><p align=“left”> /// <strong><font face=“Arial” size=“3” color=“#FFFFFF”>Profile</font></strong></td> /// <td width=“22%” colspan=“2” nowrap bgcolor=“#800000” height=“21”><p align=“center”><font /// color=“#FFFFFF” face=“Arial”><strong>FPRPT</strong><sup></sup><strong>Market Volume </strong></font></td> /// <Itr> /// <tr> /// <td width=“1%” height=“21”></td> /// <td width=“11%”height=“21” bgcolor=“#EBEBEB” nowrap colspan=“2”> /// <font face=“Arial”> /// &nbsp;</font></td> /// <td width=“10%” colspan=“2” height=“21” bgcolor=“#EBEBEB” align=“center” nowrap> /// <b><font size=“2” face=“Arial”>Daily Defaults </font></b></td> /// <td width=“10%” height=“21” bgcolor=“#EBEBEB” align=“center” nowrap>&nbsp;</td> /// <td width=“10%” height=“21” bgcolor=“#EBEBEB” align=“center” nowrap>&nbsp;</td> /// <td width=“3%” height=“21” bgcolor=“#EAD690” nowrap align=“center”>&nbsp;</td> /// <td width=“2%” height=“21” bgcolor=“#EAD690” nowrap align=“center”>&nbsp;</td> /// <td width=“11%” bgcolor=“#FFFFFF” nowrap height=“21”><small>US$</small></td> /// <td width=“12%” align=“right” bgcolor=“#FFFFFF” nowrap height=“21”><small>$308,409,868</small></td> /// <Itr> /// <tr>11<td width=“1%” height=“21”></td> /// <td width=“1%” height=“21” bgcolor=“#EBEBEB” nowrap><b> /// <font face=“Arial” size=“2”>ID</font></b></td> /// <td width=“110%” height=“21” bgcolor=“#EBEBEB” nowrap><b> /// <font face=“Arial” size=“2”>Description</font></b></td> /// <td width=“10%” height=“21” bgcolor=“#EBEBEB” align=“center” nowrap><b> /// <font face=“Arial” size=“2”>MBF</font></b></td> /// <td width=“10%” height=“21” bgcolor=“#EBEBEB” align=“center” nowrap><b> /// <font face=“Arial” size=“2”>US$/MBF</font></b></td> /// <td width=“10%” height=“21” bgcolor=“#EBEBEB” align=“center” nowrap>&nbsp;</td> /// <td width=“10%” height=“21” bgcolor=“#EBEBEB” align=“center” nowrap>&nbsp;</td> /// <td colspan=“10”><p align=“left”><strong><br> /// FPRPT|</strong>Contact Us<strong>|</strong>Mission <strong>|</strong> /// Products <strong>|</strong> Data Standards <strong>1</strong>Disclaimer<br> /// </td> /// </tr> /// <tr> /// <td width=“8%” height=“2” nowrap></td> /// <td width=“1%” height=“2”></td> /// <td width=“85%” bgcolor=“#EAD690” height=“2” colspan=“10”><br> /// <small><small>©2005 FPRPT. The <sup></sup><sup></sup><sup></sup><sup></sup><sup></sup><sup></sup><sup></sup>FPRPT logo is a trademark of FPRPT. /// All Rights Reserved. </small></small></td> /// </tr> /// </table><p>&nbsp;</p><p align=“center”>&nbsp;</p>I</body> /// </html> ///

While the particular embodiments have been illustrated and/or described, many changes can be made without departing from the spirit and/or scope of the invention. For example, the particular embodiments may further include transactions conducted over local- or wide-area networks other than the Internet. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method, comprising:
providing a first graphical user interface displayable on a display device, the first interface operable to enable a data provider to provide multiple sets of forest-product-market data, each data set being provided by the data provider at a time of the provider's choosing; and
providing a second graphical user interface displayable on a display device, the second interface operable to enable a data consumer to view at least one of the data sets.

2. A computer-readable medium having computer-executable instructions for performing the steps of:
receiving from a data provider multiple sets of forest-product-market data, each data set being submitted by the data provider at a time of the provider's choosing; and
presenting at least one of the data sets to a data consumer.
